(19) United States
(12) Patent Application Publication
(10) Pub. No.: US 2008/0125147 A1
(43) Pub. Date: May 29, 2008

(54) Text message broadcasting

(76) Inventor: Nicholas A. Maguire, Southport (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/604,642

(22) Filed: Nov. 27, 2006

(51) Int. Cl. H04Q 7/20; H04M 1/00

(52) U.S. Cl. 455/466; 455/550.1

(57) ABSTRACT

In an embodiment, a first text message is received from a messaging initiator agent, the first text message comprising subscriber content. The subscriber content is sent in a second text message to one or more wireless communication units on a subscription list. A third text message may be sent to the messaging initiator agent, the third text message including an indication of a number of second text messages sent. The first text message may be received from a wireless communication unit or a personal computer associated with the messaging initiator agent over a network.

### BACKGROUND

Text messaging is a fast and convenient way to communicate short messages between users of cellular telephones. There are also information services that use text messaging to deliver content of interest (e.g., news, weather, sports, financial markets, entertainment) to a base of subscribers.

### SUMMARY

In an embodiment, a first text message is received from a messaging initiator agent, the first text message comprising subscriber content. The subscriber content is sent in a second text message to one or more Wireless communication units on a subscription list. A third text message may be sent to the messaging initiator agent, the third text message including an indication of a number of second text messages sent. The first text message may be received from a wireless communication unit or a personal computer associated with the messaging initiator agent over a network.

The first text message may be a short message service (SMS) text message addressed to an SMS shortcode that includes a keyword indicating a particular subscription list. In an embodiment, the messaging initiator agent is an advertising entity and the subscriber message content comprises an advertisement.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates an embodiment of a communications configuration.

FIG. 2 illustrates a message flow between an agent, a server and subscribers.

FIG. 3 illustrates an embodiment of a server.

FIG. 4 illustrates a flowchart of a sequence that may be used to handle subscription to a keyword service.

FIGS. 5A-5B illustrate a flowchart of a sequence that may be used to handle messaging from an agent to subscribers of a keyword service.

### DETAILED DESCRIPTION

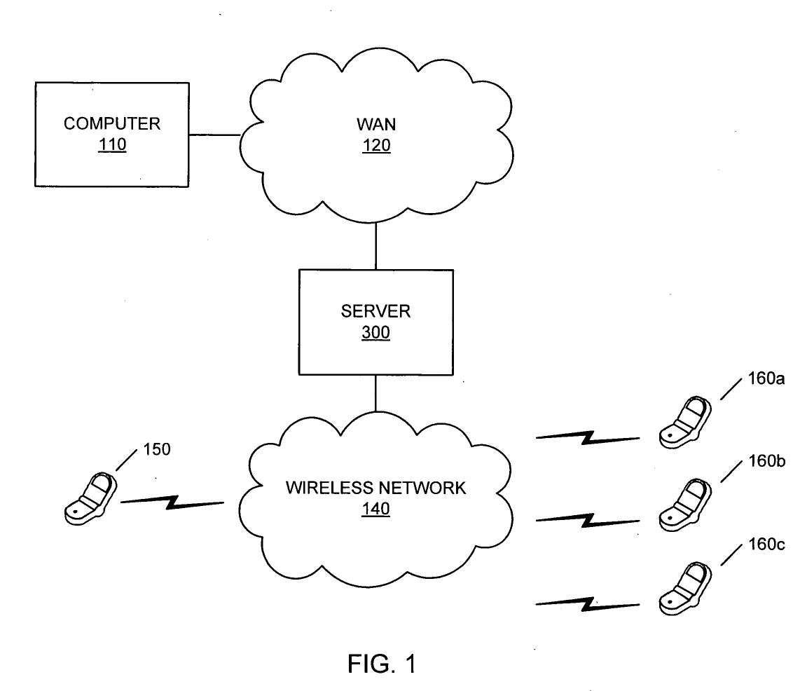

FIG. 1 illustrates an embodiment of a communications configuration featuring elements that may be used with the techniques described herein. The configuration includes a computer 110 that connects across a wide area network to a server 300. The computer 110 may be a conventional personal computer configured to include an internet browser for accessing the server 300. The server 300 connects across a wireless network 140 to wireless communication units 150, 160a, 160b, 160c. The wireless communication units may be any wireless device, including cellular telephones, personal digital assistants equipped with modems or any other handheld device capable of accessing a network over a wireless communication medium.

As described further herein, the wireless communication unit 150 is associated with a messaging initiator agent that may send messages to wireless communication units 160 associated with a list of users who have registered or subscribed to a messaging service in order to receive messages from the messaging initiator agent. The messaging initiator agent may be an advertiser and the messages may include advertisements that are targeted at the subscribers.

It should be understood that for simplicity only one messaging initiator agent is shown; however, the techniques described herein apply to configurations that may include additional messaging initiator agents. It should be further understood that any number of communication units 160 may be included as subscribers to the messaging service described herein and may be associated with one or more messaging initiator agents to that keyword subscription list. Further, more than one messaging initiator agent may be authorized to send messages to a particular list of subscribers.

In an embodiment, a user joins a particular subscription list by sending from a wireless communication unit 160 a short message service (SMS) text message containing a keyword to a specified SMS shortcode associated with provision of the messaging service. For example, the user may text DINER to 80480 to join the subscription list for a favorite diner, where 80480 is an SMS shortcode. The messaging initiator agent associated with the subscription list for the keyword DINER may broadcast to the entire subscription list via SMS text message across the wireless network 140. The messaging initiator agent may associate one or more wireless communication units 150 (based on their mobile telephone numbers) to a particular keyword.

In an embodiment, the broadcast message is sent in the form of an SMS message:

<broadcast command><keyword><message content> to <shortcode>

An example broadcast message may be “SEND DINER 25% off all menu items today” to 80480 SMS shortcode, where SEND is a broadcast command and DINER is a unique keyword associated with a messaging initiator agent and list of subscribers. The message content may be a freeform text message. The shortcode is a service number, usually five digits long, specially used for SMS services.

When server 300 receives the broadcast command, it checks to see if the broadcast initiation is from an authorized wireless communication unit for that keyword, and if it is, the service then proceeds to forward the message “25% off all menu items today” to all wireless communication units on the subscriber list for the DINER keyword. The messaging initiator agent receives an SMS message from the server 300 indicating how many messages are being sent, e.g., “broadcast for DINER in progress 3000 messages being sent.”

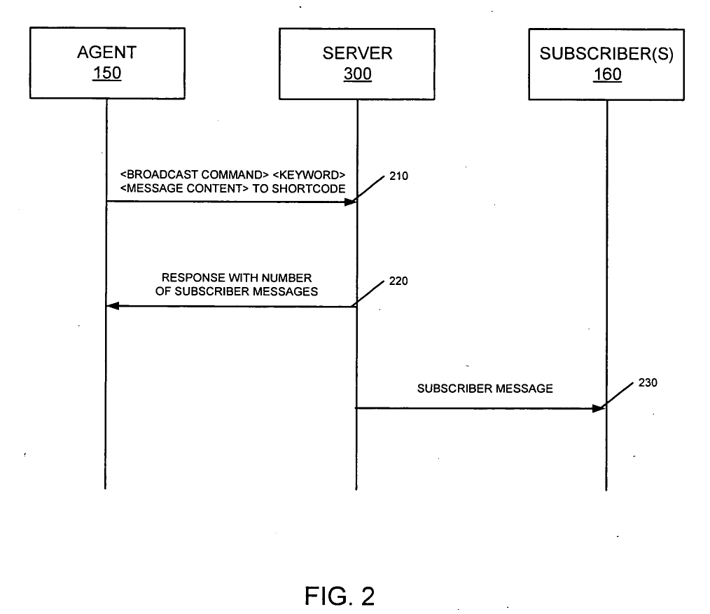

FIG. 2 illustrates an example message flow between the agent 150 and the server 300, and the server 300 and the subscribers 160. The agent sends an SMS text message 210 of the form <broadcast command><keyword><message content> to an SMS shortcode. The server processes the received text message 210 and an SMS text message 220 is sent from the server to the agent in response with an indication of the number of subscriber messages being sent. The server sends SMS text messages 230 with the message content received from the agent to the subscribers.

With the present approach, businesses are able to communicate to their customers in a more cost effective, timely and relevant way than traditional communication methods. There is no need to purchase computer systems; therefore, the connection between customers and businesses is made more simple and personal. The techniques described herein may be used for any type of broadcast messaging, including corporate communications, advertising, marketing and promotional activity.

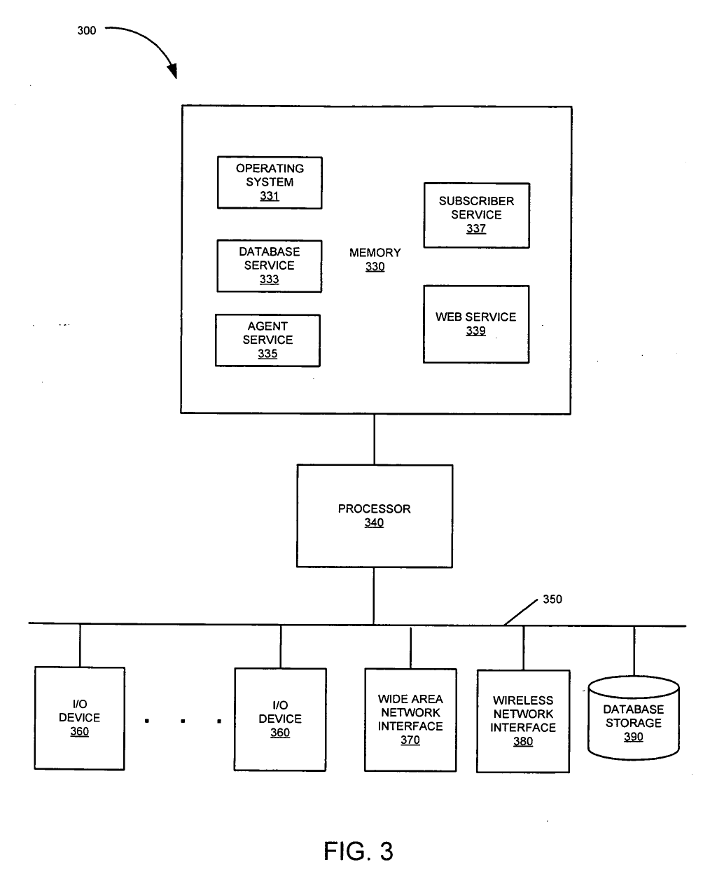

FIG. 3 illustrates an example server 300 that may be used with the techniques described herein. Server 300 comprises a memory 330 that is coupled to a processor 340 that is also coupled to one or more I/O interfaces 360, wide area network (WAN) interface 370 and wireless network interface 380 via an I/O bus 350.

The WAN network interface 370 is a conventional network interface comprising circuitry that illustratively connects the server 300 to WAN 120 and enables information to be transferred between server 300 and WAN 120. To that end, network interface 370 incorporates signal, electrical and mechanical characteristics, and interchange circuits, needed to interface server 300 with the physical media of WAN 120 and protocols running over that media.

Likewise, the wireless network interface 380 is a conventional wireless network interface comprising circuitry that illustratively connects server 300 to wireless network 140 to enable information transfer between server 300 and wireless network 140. The signal, electrical and mechanical characteristics, and interchange circuits, needed to connect server 300 with the physical media of wireless network 140 and protocols running over that media are incorporated in wireless network interface 380.

The processor 340 is a conventional CPU comprising processing circuitry configured, inter alia, to execute computer-executable instructions and manipulate data contained in memory 330. The I/O interfaces 360 comprise circuitry that interface various input and/or output devices (not shown) with the processor 340, such as, e.g., keyboards, display units and the like. The memory 330 is a computer-readable medium organized as a RAM that is implemented memory devices which may be some combination of volatile and non-volatile devices. The memory is configured to hold computer-executable instructions and data structures including computer-executable instructions and data structures that implement aspects of the present invention.

The memory 330 illustratively contains an operating system 331 and processes such as database service 333, agent service 335, subscriber service 337 and web service 339. The operating system 331 may be a conventional multi-tasking operating system configured to implement various conventional operating system functions which may include scheduling processes for execution, managing memory 330 and controlling access to devices coupled to the I/O interfaces 360.

The database service 333 comprises computer executable instructions configured to maintain subscriber lists on database storage 390. The agent service 335 comprises computer executable instructions configured to process text messages between wireless communication unit 150 and server 300. The subscriber service 337 comprises computer executable instructions configured to process text messages between wireless communication units 160 and server 300 for updating and managing the registration of wireless communication units 160 on subscription lists stored on database storage 390. The web service 339 comprises computer executable instructions configured to implement a web service that may be used by a messaging initiator agent to send text messages from computer 110 to the server 300 across WAN 120.

Operationally, server 300 receives information (e.g., data packets) from the WAN 270 at its network interface 370 or from wireless communication unit 150 over wireless network 140 at its network interface 380. The received information is forwarded to the processor 340 for further processing. Processor 340 processes the information which may include generating responses, forwarding information onto the wireless network 140 via wireless network interface 380 to wireless communication units 150, 160, checking authorization of users associated with the information and so on.

In another embodiment, the server 300 connects to a third party over WAN 120 using WAN interface 370 in order to send and receive text messages. The third party in turn transmits and receives the text messages directly to and from the wireless network 140.

It should be noted that functions performed by the server 300, including functions that implement aspects of the techniques described herein, may be implemented in whole or in part using some combination of hardware and/or software. It should be further noted that computer-executable instructions and/or data that implement aspects of the techniques described herein may be stored in various computer-readable mediums, such as flash memories, removable disks, non-removable disks and the like. In addition, it should be noted that various electromagnetic signals such as wireless signals, electrical signals carried over a wire, optical signals carried over optical fiber and so on may be encoded to carry computer-executable instructions and/or data that implement aspects of the present invention on, e.g., a communication network.

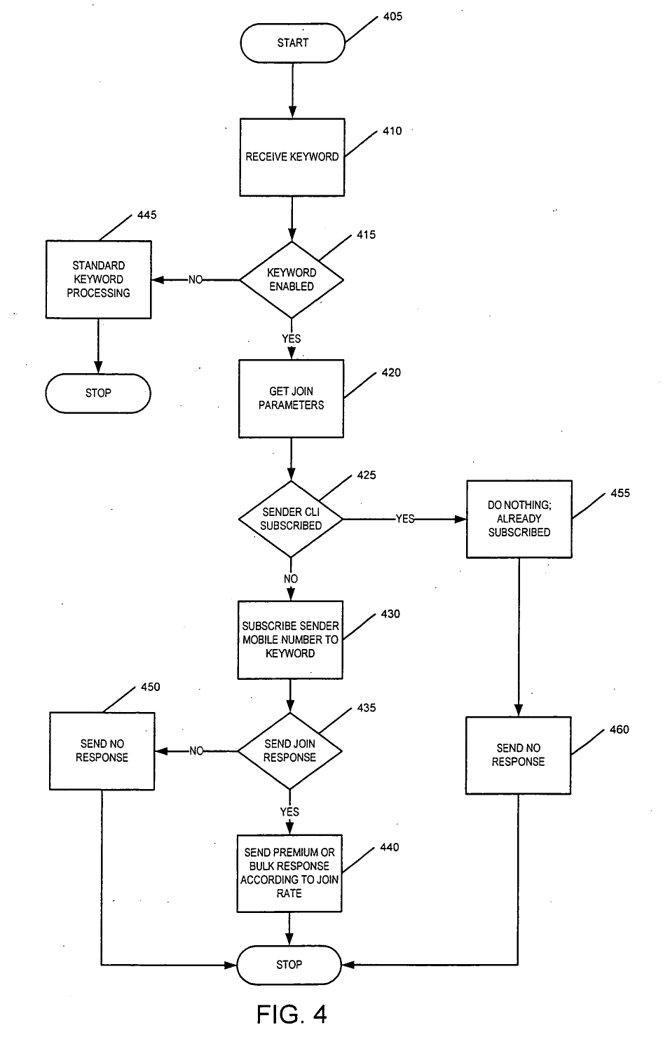

FIG. 4 illustrates a flowchart of a sequence that may be used at the server 300 with subscriber service 337 to register a wireless communication unit 160 of a subscriber to join a subscription list associated with a text messaging service. The sequence begins at 405 and proceeds to 410 where a keyword is received at the receiver from a sender. At 415 a check is performed to determine if the keyword is enabled for the text service. If the keyword is not enabled for the broadcast text messaging service described herein, the sequence proceeds to 445 for standard keyword processing and the sequence stops. The term “standard keyword processing” simply means that the SMS message is handed off or passed along to other services or applications that may handle SMS on the network, which are unrelated to the broadcast text messaging service. If the keyword is enabled, the sequence continues at 420 where parameters associated with joining a subscription list are retrieved from database storage 390.

At step 425 a check is made to determine if the sender is already subscribed based on a lookup of the sender's calling line information (CLI) (e.g., mobile telephone number) in the subscription list for that keyword retrieved from database storage 390. If the sender is already subscribed, then at 455 no response is sent to the sender at 460 and the process stops. Otherwise, processing continues at 430 with the subscription list for that particular keyword being updated with the CLI of the sender.

At 435 a check is performed to determine whether to send an optional join response message to the sender. This may be determined by a customer selection at the creation of the service whether to incur the cost of sending a welcoming join response back to the subscriber. If a join response is not to be sent, then at 450 a NO response is sent to the sender and the process stops. Otherwise, a premium or bulk response according to the join rate setting is sent to the sender and the process stops.

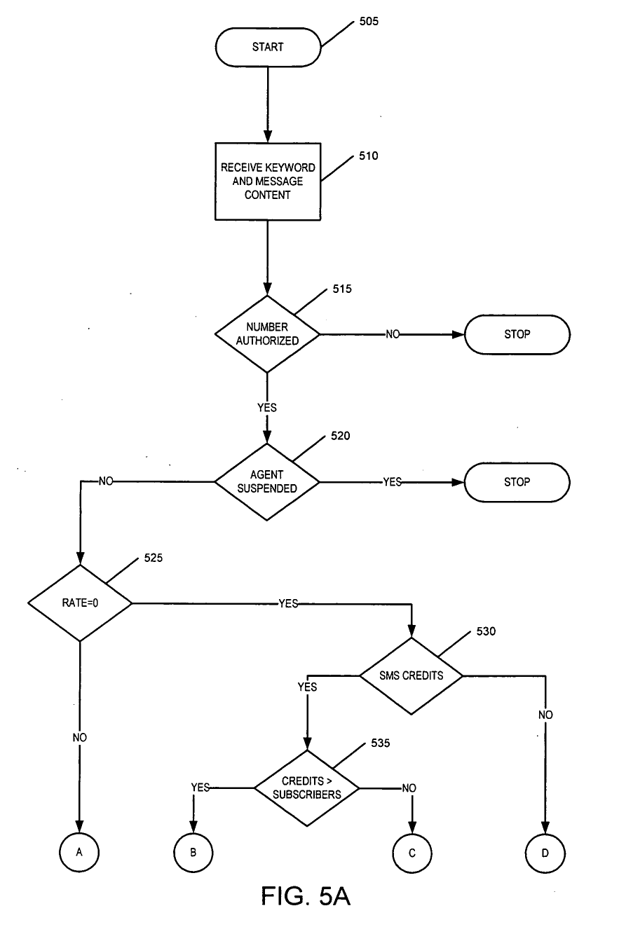

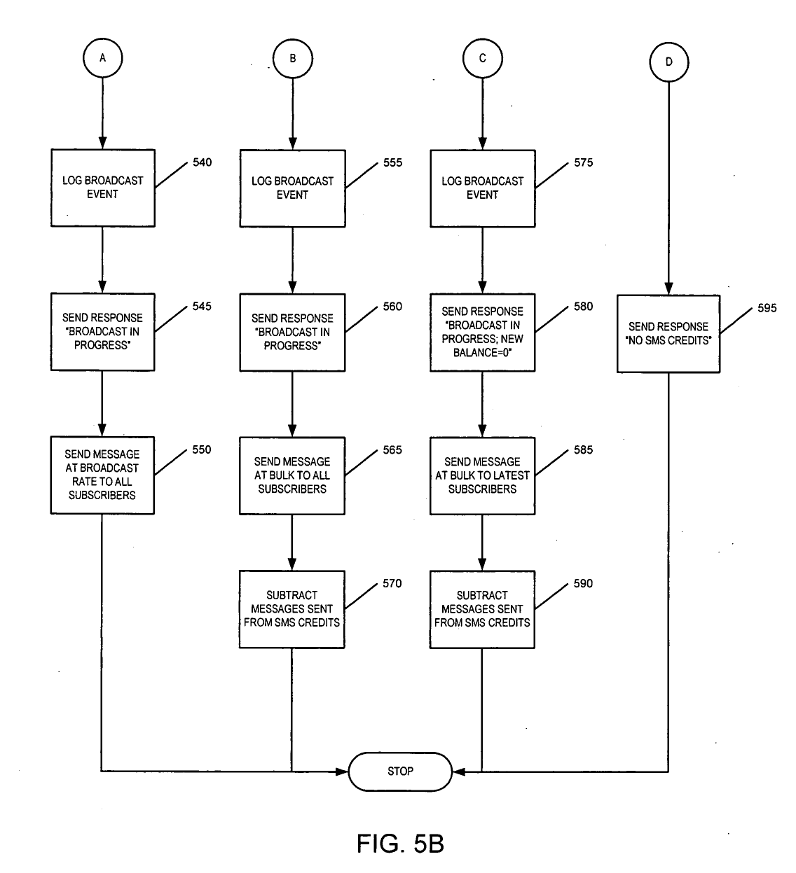

FIGS. 5A-5B illustrate a flowchart of a sequence that may be used at the server 300 with agent service 335 to handle messaging by a wireless communication unit 150 of a messaging initiator agent associated with a text messaging service. The sequence begins at 505 and proceeds to 510 where the server 300 receives a keyword and message content from a sender. At 515 a check is made to determine whether the CLI or mobile telephone number of the sender is authorized as a messaging initiator agent for this particular keyword. If the sender is not authorized, then processing stops. Otherwise, the sender is deemed a valid messaging initiator agent and processing continues at 520 where a check is performed to determine whether the agent is suspended. The CLI may be valid but that particular sender may not be “active.” In cases where a business has shared mobile telephones, one user may be suspended because they do not currently have possession of the telephone. Another scenario may be that the agent is on holiday and has suspended services temporarily due to inactivity. Yet another scenario is that the agent may be suspended to allow for investigation of a claim or an account issue. If the agent is suspended, then processing stops. Otherwise, processing continues at 525 where a check is made to determine if this particular keyword service is delivered free to subscribers or if the subscriber is charged to receive the text messages.

If the service is not free to the subscribers, then processing continues at 540 where a broadcast event is logged to the database storage 390. At 545 a response “broadcast in progress” is sent to the agent with an indication of the number of messages being sent. For example, if there are 100 subscribers to the keyword service, then the response indicates that 100 messages are being sent. At 550 the text message is sent to the subscribers on the subscription list at a broadcast rate. For example, consider a subscriber to a pop band who receives a text message from the band manager as the agent. With reverse billed SMS, the subscriber is charged for the text message.

If at 525 it is determined that the service is free to subscribers, then at 530 there is a check made of the agent's account to see if there are enough SMS credits to cover the cost of the broadcast to the subscribers. (An SMS credit is a unit which represents in monetary terms the cost the service to broadcast one SMS message. One credit is used each time a subscriber is sent a text message.) If there are no SMS credits available to the agent, then at 595 a text message is sent back to the agent indicating “no SMS credits” and information on how to get more credits. If there are SMS credits, a check is made at 535 to determine whether the number of credits is more than the number of subscribers for the keyword service. If the number of credits is greater than the number of subscribers, then at 555 a broadcast event is logged and a response “broadcast in progress” is sent to the agent at 560 with an indication of the number of messages being sent. At 565 the text message is sent to all subscribers on the subscription list at a bulk SMS billing rate charged to the agent's account. The number of messages sent is subtracted from the agent's SMS credits at 570.

If at 535 there are not enough SMS credits to cover a broadcast to the entire subscription list, then only a subset of the list is sent the text message based on some type of selection criteria. For example, the selection may favor those subscribers who have received the fewest number of broadcasts historically, or the most recent subscribers. Processing continues at 575 where a broadcast event is logged and a response “broadcast in progress; new balance=0” is sent to the agent at 580 with an indication of the number messages being sent. At 585 the text message is sent to those selected subscribers until the number of credits equals zero or a predetermined threshold. At 590 the number of messages sent is subtracted from the agent's SMS credits and processing stops.

The foregoing has described text messaging in which the messaging initiator agent sends a broadcast command to the server in order to initiate a broadcast to a list of subscribers to a particular text messaging service. In another embodiment, the agent may initiate the broadcast by accessing server 300 over WAN 120 using computer 110 (FIG. 1) to send the broadcast message.

While this invention has been particularly shown and described with references to example embodiments thereof, it will be understood by those skilled in the art that various changes in form and details may be made therein without departing from the scope of the invention encompassed by the appended claims.

What is claimed is:

1. A method comprising:
receiving a first text message from a messaging initiator agent, the first text message comprising subscriber content; and
sending the subscriber content in a second text message to one or more wireless communication units on a subscription list.

2. The method of claim 1 further comprising sending a third text message to the messaging initiator agent, the third text message including an indication of a number of second text messages sent.

3. The method of claim 1 wherein the first text message is received from a wireless communication unit associated with the messaging initiator agent over a wireless network.

4. The method of claim 1 wherein the first text message is received from a personal computer associated with the messaging initiator agent over a wide area network.

5. The method of claim 1 wherein the first text message is a short message service (SMS) text message addressed to an SMS shortcode.

6. The method of claim 1 wherein the first message includes a keyword indicating a particular subscription list.

7. The method of claim 1 further comprising determining whether the messaging initiator agent is authorized to send the first text message based on examination of a wireless phone number associated with the messaging initiator agent.

8. The method of claim 1 further comprising adjusting an account balance associated with the messaging initiator agent based on the number of second text messages sent.

9. The method of claim 1 further comprising receiving from an additional wireless communication unit a fourth text message that includes a keyword associated with the subscription list and adding the additional wireless communication unit to the subscription list.

10. The method of claim 1 wherein the messaging initiator agent is an advertising entity and the subscriber message content comprises an advertisement.

11. Apparatus comprising:
a database comprising a subscription list of wireless communication units;
processing circuitry coupled to the database and configured to receive from a messaging initiator agent a first text message comprising subscriber content and send the subscriber content in a second text message to one or more wireless communication units on the subscription list.

12. The apparatus of claim 11 wherein the processing circuitry is further configured to send a third text message to the messaging initiator agent, the third text message including an indication of a number of second text messages sent.

13. The apparatus of claim 11 wherein the first text message is received from a wireless communication unit associated with the messaging initiator agent over a wireless network.

14. The apparatus of claim 11 wherein the first text message is received from a personal computer associated with the messaging initiator agent over a wide area network.

15. The apparatus of claim 11 wherein the first text message is a short message service (SMS) text message addressed to an SMS shortcode.

16. The apparatus of claim 11 wherein the first message includes a keyword indicating a particular subscription list.

17. The apparatus of claim 11 wherein the processing circuitry is further configured to determine whether the messaging initiator agent is authorized to send the first text message based on examination of a wireless phone number associated with the messaging initiator agent.

18. The apparatus of claim 11 wherein the processing circuitry is further configured to adjust an account balance associated with the messaging initiator agent based on the number of second text messages sent.

19. The apparatus of claim 11 wherein the processing circuitry is further configured to update the subscription list by receiving from an additional wireless communication unit a fourth text message that includes a keyword associated with the subscription list and adding the additional wireless communication unit to the subscription list.

20. Apparatus comprising:
means for receiving a first text message from a messaging initiator agent, the first text message comprising subscriber content;
means for sending the subscriber content in a second text message to one or more wireless communication units on a subscription list.
